(19) United States
(12) Patent Application Publication
(10) Pub. No.: US 2023/0417299 A1
(43) Pub. Date: Dec. 28, 2023

(54) Brake drum with dust-guiding groove for guiding brake dust towards a brake dust collector

(71) Applicant: HL Mando Corporation, Pyeongtaek (KR)

(72) Inventor: Hatem SHAHIN, Pfaffenhofen (DE)

(21) Appl. No.: 18/338,394

(22) Filed: Jun. 21, 2023

(30) Foreign Application Priority Data
Jun. 22, 2022 (DE) 102022206245.0

(51) Int. Cl. F16D 65/10; F16D 65/00

(52) U.S. Cl. CPC F16D 65/10; F16D 65/0031; F16D 2065/1304

(57) ABSTRACT

The invention relates to a brake drum for a vehicle drum brake,
the brake drum comprising:
an inner circumferential surface that extends around a rotation axis and that is configured to be contacted by a brake shoe for generating a braking effect; and
a brake dust collector;
wherein at least one dust-guiding groove is provided in the circumferential surface and extends towards the brake dust collector.

### CROSS-REFERENCE TO RELATED APPLICATION

This application is based on and claims priority under 35 U.S.C. § 119 to German Patent Application No. 102022206245.0, filed on Jun. 22, 2022 in the German Patent and Trade Mark Office, the disclosures of which are incorporated herein by reference.

### TECHNICAL FIELD

The invention concerns a brake drum for a drum brake of a motor vehicle, such as a car, a truck or a bus.

### BACKGROUND

Drum brakes are an established braking technology for motor vehicles. They typically comprise a brake drum having a contact surface at an inner circumferential face and a backing plate carrying brake shoes which have a friction lining for contacting the contact surface. An example can be found in KR 2006 006 3092 A.

There remains room for improvement with respect to the levels of brake dust that are emitted into the surroundings. Upon braking, the abrasive contact between the friction lining and contact surface generates brake dust. The brake dust can soil the brake drum itself as well as adjacent vehicle components. Also, it can be emitted into the surroundings, thereby polluting the environment. Accordingly, attempts have been made to limit the levels of emitted brake dust, e.g. by providing a dust-tight casing which encloses the brake drum. Yet, such solutions increase costs and weight.

### SUMMARY

It is therefore an object of this invention to improve the brake drum for a drum brake of a motor vehicle with respect to its brake dust emissions.

This is object is achieved by a brake drum and a method according to claim 1. Advantageous embodiments are defined in the dependent claims as well as in this description and in the figures.

Accordingly, a brake drum for a vehicle drum brake is suggested, the brake drum comprising:
an inner circumferential surface that extends around a rotation axis and that is configured to be contacted by a brake shoe for generating a braking effect; and
a brake dust collector;
   wherein at least one dust-guiding groove is provided in the circumferential surface and extends towards the brake dust collector.

Terms such as axial, radial and circumferential used herein may relate to the rotation axis. An axial direction may extend along said axis, a radial direction may extend orthogonally thereto and a circumferential direction may extend about said axis.

The brake drum may comprise a homogeneous drum member (e.g. with respect to its material) and/or a one-piece drum member. This drum member may directly comprise the inner circumferential surface in which the dust-guiding grooves are formed. As detailed below, the drum member may alternatively carry a friction ring comprising said inner circumferential surface.

The brake drum and in particular its optional drum member may comprise a ring section extending concentrically about a rotation axis. The ring section may be circular. It may define a cylindric section, in particular a cylinder mantel surface or cylinder jacket (e.g. a cylinder without base surfaces). The ring section may define an outer and/or inner circumferential face of the brake drum and may comprise the inner circumferential surface in which the dust-guiding groove is formed. The ring section may define a largest diameter of the brake drum.

The brake drum and in particular its optional drum member may comprise a circular wall section extending at an angle to the rotation axis. The wall section may be plate- or disc shaped and/or may be substantially planar. It may extend orthogonally to the rotation axis. It may merge with and/or into the ring section. The ring section may extend orthogonally to the wall section. The wall section may extend concentrically with respect to the rotation axis.

The wall section may comprise a connection portion for connecting the brake drum to an axle component and/or to a vehicle wheel. The brake drum may generally be configured to rotate jointly with the axle component and/or the vehicle wheel. The connection portion may be a hub portion. It may comprise a least one through-hole, e.g. for receiving a mechanical fixing element (e.g. a bolt). The connection portion may be positioned at the wall section and/or may comprise a geometric center of the wall section. It may be intersected by the rotation axis.

The wall section may form a base surface of a cylinder, the mantle of which is formed by the ring section. The brake drum may be formed as a cylinder that is open to one side, e.g. by missing a base surface opposite to the wall section.

The brake dust collector may be arranged at the wall section. It may be arranged at an inner face of the wall section that faces towards the inner circumferential surface and/or merges with said inner circumferential surface.

The brake dust collector may be a planar member and in particular a disc-shaped member. It may comprise a structured (in particular non-smooth) surface that is e.g. rough, porous or otherwise opened. Additionally or alternatively, said surface may comprise edges, projections, recess and/or undercuttings. These structural features may help to catch and collect brake dust particles.

Additionally or alternatively, the brake dust collector may comprise an adhesive material, e.g. an adhesive layer or an adhesive coating to which brake dust particles may adhere.

The brake dust collector may be removably connected to the brake drum, e.g. by being mechanically fixed thereto (e.g. by means of clamps, screws or a force fit) or by being adhered thereto. This way, the brake dust collector can be replaced to restore a dust collecting capability of the brake drum.

The dust-guiding groove may generally be configured to guide brake dust towards the brake dust collector. Specifically, it may be configured to guide the brake dust from its place of origin at the inner circumferential surface towards the brake dust collector. Said brake dust collector may generally be close to but arranged separately from and e.g. next to the inner circumferential surface.

The dust-guiding groove may also be referred to as a dust-guiding slot, a dust-guiding recess or a dust-guiding channel. The dust-guiding groove may be formed by an elongated cut-out section of material that is removed from the brake drum. The dust-guiding groove may be open on its radially inner side (i.e. the side that faces the rotation axis). Other than that, it may have closed sidewalls and/or may e.g. have a cross-section that is only open on said radially inner side.

The dust-guiding groove may have at least one open axial end face that e.g. opens into the surroundings of the brake drum and/or faces the brake dust collector. Alternatively, at least one axial end portion may be located within the inner circumferential surface. It may define a region of a gradually decreasing depth and/or a ramped or levelling-off end portion of the dust-guiding groove.

In one example, the groove has a depth (e.g. measured in a radial direction and/or relative to the inner circumferential surface) of at least 0.5 mm, at least 1 mm or at least 3 mm. This has been found to provide a reliable dust guiding function. On the other hand, the depth may not be larger than 10 mm, not larger than 20 mm and not larger than 50 mm. While such a depth may still provide benefits in terms of dust guidance, it could unduly weaken the structure of the brake drum.

A width of the groove that is e.g. measured orthogonally to the depth and orthogonally to a longitudinal axis of the groove may e.g. be between 2 mm and 50 mm A length of the groove may be at least 10 cm or may be at least 20 cm, but may be smaller than a circumference of the inner circumferential surface (or smaller than 1.5 times said circumference). Generally, a larger length may increase the chances of collecting dust in the groove and guiding it towards the brake dust collector. On the other hand, the increased length may structurally weaken the brake drum and/or occupy a respectively increased share of the area of the inner circumferential surface. This share is not available for brake force generation when being contacted by a brake shoe.

Accordingly, according to one embodiment, a share of the surface area of the inner circumferential surface in which the dust-guiding groove extends (and in particular in which all dust-guiding grooves of an optional plurality extend) may be below 20% and in particular below 10% or below 5%.

The suggested brake drum arranges a brake dust collector directly within the suggested brake drum, so that brake dust emissions into the surroundings may be limited.

Also, by providing the dust-guiding groove, the share of generated brake dust that is collected by the brake dust collector may be increased. The dust-guiding groove can be simple to produce, e.g. directly when casting, forging or machining the brake drum.

Further, the dust-guiding groove helps to reduce weight and introduces a surface structure that can help to limit the generation of brake noises. Specifically, the dust-guiding groove may help to absorb or otherwise disturb soundwaves which may thus no longer contribute to generated acoustic brake noises.

Still further, the dust-guiding groove can be used as a design parameter for adjusting the dynamic behaviour (i.e. the vibration characteristics) of the brake drum in a desired manner. For example, it can generally be desired to set the eigenfrequencies of the brake drum clearly apart from other brake components and/or adjacent vehicle components to limit vibrational couplings therewith. By positioning, sizing and shaping the dust-guiding grooves appropriately, a respective adjustment of the eigenfrequencies is possible, in particular without adding additional masses or a complex redesigns of the brake drum's overall shape.

According to a further embodiment, the dust-guiding groove extends from a first end portion at a first axial distance to the brake dust collector to a second axial end portion that is axially closer to the brake dust collector. Accordingly, the dust-guiding groove may generally be configured to guide brake dust from regions that are at an axial distance to the brake dust collector towards the brake dust collector.

In one example, the dust-guiding groove has a non-linear course. For example, the dust-guiding groove may have a bent or curved course as e.g. defined by a longitudinal axis of said groove. Nonetheless, a linear course can be provided as well, this linear course e.g. being non-horizontal and/or non-vertical and/or run diagonally along the inner circumferential surface and towards the brake dust collector.

According to a further aspect, the dust-guiding groove extends along the circumferential surface while covering a circumferential distance as well as an axial distance, thereby achieving a reliable dust guidance towards the brake dust collector.

In one example, the dust-guiding groove defines at least a segment of a helix and/or may be helix-shaped. This helps to prevent sharp edges or angles that could locally increase mechanical stresses. Also, this helps to increase a length of the dust-guiding groove at limited axial dimensions. A slop of said helix may be constant or may vary along its length.

Generally, a plurality of dust-guiding groove may be provided. At least segments of a dust-guiding groove, in particular one or both end sections, may be arranged at an angular distance to another dust-guiding groove. The angular distance may e.g. be between 20° and 180°). Increasing the number of dust-guiding grooves may increase the brake dust guiding capability and thus brake dust collecting capability of the brake drum.

In one example, there are at least two dust-guiding grooves which, at least in one segment, extend next to and/or along and/or in parallel to one another. Put differently, a first dust-guiding groove having a first segment and a second dust-guiding groove having a second segment may be provided, wherein the first and second segment extend next to and/or along and/or in parallel to one another.

When a plurality of dust-guiding grooves is provided, the dust-guiding grooves may be sized and shaped similarly. Yet, at least segments thereof may be circumferentially offset relative to one another. For example, each dust-guiding groove may have a similar course, e.g. defining a helix-segment, but may start from an individual circumferential position. Thus, a plurality of circumferentially spaced dust-guiding grooves may be provided forming in particular circumferentially spaced helix segments.

According to another embodiment, the circumferential surface is comprised by a friction ring that is arranged at an inner circumferential face of a drum member of the brake drum. In this case, the brake drum may have a multi-part design with at least the drum member and friction ring formed as separate, yet connected members. The friction ring may e.g. be mechanically connected to the drum member or may be welded or glued thereto. Such multi-part design of the brake drum may be beneficial in that the friction ring can be specifically adapted to interact with the brake shoes. The drum member, on the other hand, can have a primarily carrying and/or stabilising function, thus e.g. being made of a cheaper material compared to the friction ring.

Alternatively, the circumferential surface may be comprised by a drum member of the brake drum, the drum member e.g. being the only member of the brake drum (i.e. the brake drum having a one-piece design). This may reduce production and assembly costs.

In one embodiment, the brake dust collector is arranged in or at a surface of the brake drum extending at an angle to the rotation axis, in particular wherein the brake dust collector is arranged at a (preferably circular) wall section of the brake drum discussed above. Said wall section may form a base surface of the brake drum.

The brake dust collector may e.g. be adhered to said surface or mechanically fixed to said surface and form a layer on top of and protruding relative to said surface. The surface may generally be planar and/or smooth. Alternatively, the surface may comprise a recess in which the brake dust collector is at least partially received, e.g. is partially countersunken.

According to a further aspect, the brake dust collector may comprise at least one of:
a mesh, in particular a metallic mesh or plastic mesh;
an adhesive, in particular an adhesive surface or an adhesive coating or an adhesive layer;
a fabric, e.g. comprising a plastic textile material or natural textile material, such as cotton.

The mesh and fabric may provide a structured surface for catching dust. They may optionally be coated with an adhesive.

### BRIEF DESCRIPTION OF DRAWINGS

Embodiments of the invention are discussed below with respect to the attached schematic figures. Throughout the figures, same or similar features may be marked with same reference signs.

FIG. 1 is a cross-sectional partial view of a brake drum according to a first embodiment of the invention.

FIG. 2 is a front view of the brake drum of FIG. 1.

FIG. 3 is a cross-sectional partial view of a brake drum according to another embodiment of the invention.

FIG. 4 is a front view of the brake drum of FIG. 3.

FIGS. 5-8 show variants of the dust-guiding groove according to further embodiments of the invention.

FIGS. 9-11 show variants of the brake dust collector according to further embodiments of the invention.

### DETAILED DESCRIPTION

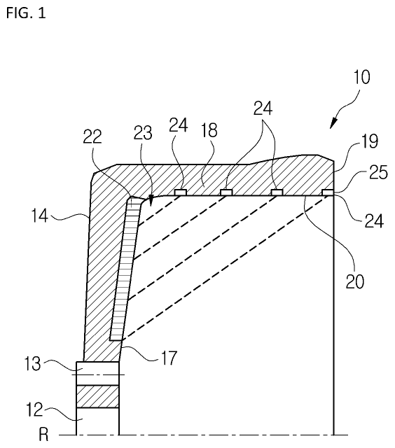

FIG. 1 is a cross-sectional view of one half of a brake drum 10 that is designed according to an embodiment of the invention. The brake drum 10 is configured to rotate about a rotation axis R. The rotation axis forms an axis of symmetry of the brake drum 10, the brake drum 10 also being concentric to said rotation axis R.

The brake drum 10 comprises a hub portion 12 for being coupled to a non-illustrated vehicle wheel and/or a rotating axle component of the vehicle. As an optional feature, the hub portion 12 comprises a number of off-centre through holes 13 for receiving mechanical fixing elements, such as bolts, for being secured to the axle component and/or to the vehicle wheel. In the embodiment of FIG. 1, the brake drum 10 is a one-piece member having an integrated drum member 14 made of a metallic material, such as cast iron.

The brake drum 10 comprises a circular wall section 16 that is plate shaped an extends at an angle to the rotation axis R. For example, the wall section 16 extends at an angle of more than 60° or more than 80° to the rotation axis R and may substantially extend orthogonally to the rotation axis R. At its geometric centre that is intersected by the rotation axis R, the wall section 16 comprises the hub portion 12.

The brake drum 10 also comprises a ring section 18. The ring section 18 is configured as a section of a cylinder mantle surface that is concentrically positioned with respect to and extends about the rotation axis R. The wall section 16 merges with the ring section 18 and extends at an angle thereto.

Said angle may e.g. amount to at least 60° or more than 80° and/or the wall section 16 may substantially extend orthogonally relative to the ring section 18. The ring section 18 extends substantially axially. It has a ring-shaped axial end face 19 forming an outer edge of the ring section 18.

At its inner circumferential surface 20, the ring section 18 has a metallic contact surface for being contacted by a non-illustrated brake shoe to generate a braking effect. In a generally known manner, the brake shoe may be configured to carry a non-illustrated friction lining that comprises a friction material. This friction material may be abraded when contacting the inner circumferential surface 20, thereby generating brake dust.

The wall section 16 forms a base surface of the drum member 14. At its inner face 17 which faces an interior of the drum member 14 and which is oriented towards the inner circumferential face 20, a brake dust collector 22 is provided. The brake dust collector 22 can be configured according to any of the examples disclosed herein, e.g. can comprise a textile material and/or a mesh and/or an adhesive substance.

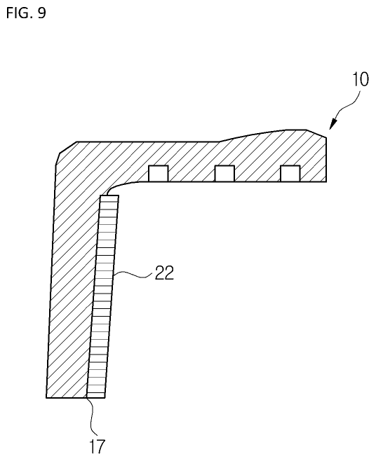

The brake dust collector 22 is configured as a ring-shaped member extending concentrically with respect to the rotation axis R. It is secured at the inner face 17 of the wall section 16 according to any of the examples discussed in connection with FIGS. 9-11 below. The brake dust collector 22 has a non-obstructed surface facing away from the inner face 17 and towards the interior of the drum member 14 as well as towards the inner circumferential face 20. Brake dust may be collected at said surface.

The inner circumferential surface 20 comprises a number of dust-guiding grooves 24. The dust guiding grooves 24 extend along at least a part of the circumferential surface 22 towards the brake dust collector 22. They are open towards the inside of the drum member 14, i.e. have a radially inner open face. They define elongated slots or recesses within the inner circumferential surface 20. By way of their open face, brake dust can enter each dust-guiding groove 24 and be guided along and within said dust-guiding groove 24 towards the brake dust collector 22. This may be supported by centrifugal forces resulting from a rotation of the brake drum 10.

The number of said dust-guiding grooves 24 in any of the depicted embodiments is merely exemplary and more or less dust-guiding grooves 24 may be provided. Also, the size of the dust-guiding grooves 24 and in particular its size relation to the drum member 14 is merely schematic. The dust-guiding grooves 24 can be significantly smaller than depicted (e.g. less wide and/or less deep).

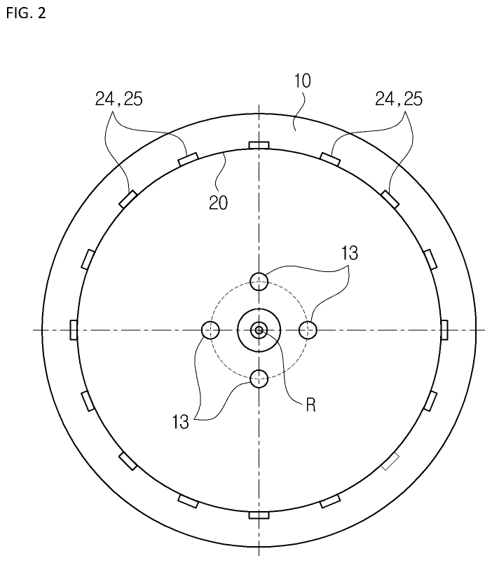

The positioning and extension of the dust-guiding grooves 24 is also discussed in the following with reference to FIG. 2. FIG. 2 is a front view of the brake drum 10 of FIG. 1, so that the rotation axis R extends orthogonally to the image plane. A number of dust-guiding grooves 24 and specifically of first end portions 25 thereof is visible in FIG. 2, not all of which are marked by an own reference sign. As a mere example, these end portions 25 open into the surroundings, thus forming an outwardly opened end section of each dust-guiding groove 24. For doing so, the end portions 25 form cutouts in the axial end face 19 of the ring section 18. This, however, is not mandatory. Alternatively, the dust-guiding grooves 24 can have a respective first end portion 25 located within the inner circumferential surface 20 and at an axial distance to the axial end face 19 of the ring section 18. In this case, the end portions 25 may form dead ends or blind ends of each dust-guiding groove 24, but may be positioned similarly and in particular may be a circumferentially distributed similarly to the example of FIG. 2.

In more detail, FIG. 2 shows that the end portions 25 of the dust-guiding grooves 24 are circumferentially spaced apart from one another. In particular, they are regularly spaced apart with angular distances between the respectively adjacent end portions 25 being constant.

Starting from an end portion 25, each dust-guiding groove 24 has an extension along the inner circumferential face 20 resembling a helix-segment. This type of extension is identical for each dust-guiding groove 24 while maintaining the circumferential spacing between the dust-guiding grooves 24. Therefore, when e.g. viewed in an axial direction, a sequence of curved dust-guiding grooves 24 defining helix-segments extends within the inner circumferential surface 20 and specifically from the axial end face 19 towards the brake dust collector 22.

In the cross-sectional view of FIG. 1, a number of dust-guiding grooves 24 is included. These dust-guiding grooves 24 are cut at different positions along their length. Only the rightmost dust-guiding groove 24 has its end portion 25 located directly in the sectional plane. The other dust-guiding grooves 24 are cut at a position remote from their respective end portion 25 (which are not comprised by the sectional plane).

A dashed line schematically illustrates the course of each dust-guiding groove 24 towards the brake dust collector 22 and along the inner circumferential face 20. This course is only highly schematically indicated by the dashed lines and can be curved according to the underlying helix shape. Nonetheless, it can be seen that the dust-guiding groove 24 extend next to and along one another from the axial end face 19 towards the brake dust collector 22.

Also, a second end portion 23 of the dust-guiding grooves is marked at which the dust-guiding grooves 24 open towards the brake dust collector 22. From FIG. 1, it can be seen that each dust-guiding groove 24 thus covers an axial distance and in particular the axial distance between the end face 19 and the brake dust collector 22.

From FIG. 1, it is also apparent that the inner circumferential surface 22 is part closed and smooth for the most, i.e. is free of the dust-guiding groove 24. The dust-guiding groove 24 only make up for or occupy less than 10% of the total surface area of the inner circumferential surface 22. Thus, there remains a sufficiently large share of the inner circumferential surface 22 that can be contacted by non-depicted brake shoes for generating brake forces.

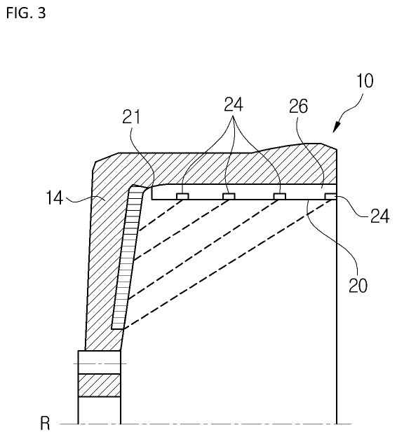

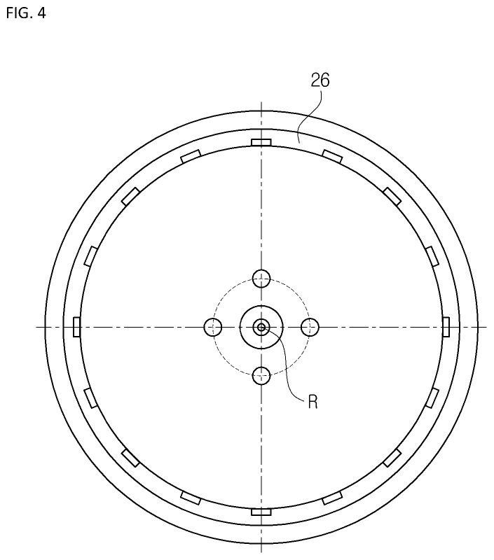

FIGS. 3 and 4 are views similar to those of FIGS. 1 and 2 and depict a brake drum 10 according to a second embodiment. The difference to the first embodiment concerns the brake drum 10 being a multi-part assembly. More precisely, the inner circumferential surface 20 in which the dust-guiding recess 24 are formed is comprised by a friction ring 26. The friction ring 26 is inserted into and fixed to a drum member 14 of the brake drum 10 and specifically to an inner circumferential face 21 of the drum member 14. It is also evident from FIG. 4 that the spacing, dimensioning and extension of the dust-guiding grooves 24 is identical to FIG. 1, with the dust-guiding grooves 24 extending within and along the inner circumferential surface 22 of the friction ring 26.

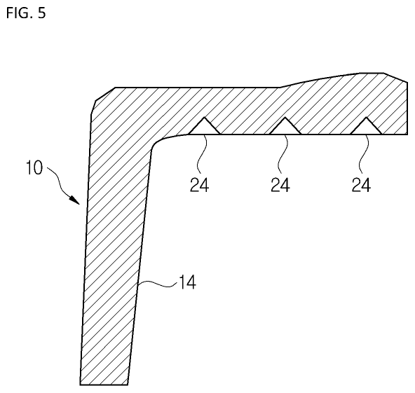

FIGS. 5 to 8 illustrate possible variants of the dust-guiding grooves 24 according to further embodiments. Only part of the brake drum 10 is illustrated in these figures (and also in the subsequent FIGS. 9-11) but the brake drum 10 can generally be designed similar to the one of FIGS. 1-2.

The depicted number of dust-guiding grooves 24 is merely exemplary and may be higher or lower. Also, FIGS. 5 to 8 show dust-guiding grooves 24 being directly formed in the drum member 14 similar to the embodiment of FIGS. 1 and 2. However said dust-guiding grooves 24 can be provided in a friction ring 26 according to the embodiment of FIGS. 3 and 4 as well.

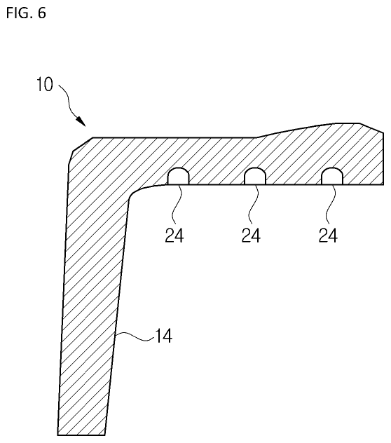

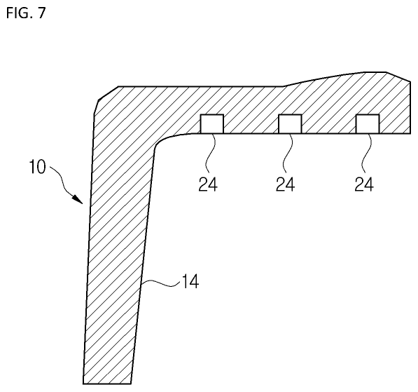

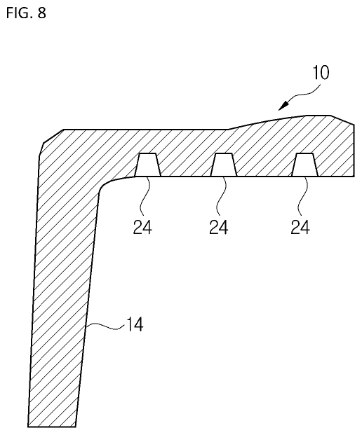

In FIG. 5, the dust guiding grooves 24 have a triangular cross-section with one side of the triangle being open towards the interior of the brake drum 10. In FIG. 6, the dust-guiding grooves 24 have a rounded and in particular a dome-shaped cross-section. Alternatively, a rounded cross-section could be half-circular or half-elliptic. In FIG. 7, the dust-guiding grooves 24 have a rectangular cross-section, whereas in FIG. 8 the cross-section is trapezoidal.

FIGS. 9-11 shows variants of arranging the brake dust collector 22 (again only part of which is visible) in the brake drum 10. In FIG. 9, the brake dust collector 22 is a separate member, e.g. a mesh or a porous disc, and is attached to a generally smooth and planar inner face 17 of the wall section 16 of the brake drum 10.

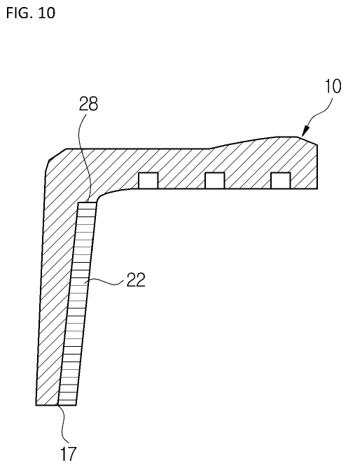

In FIG. 10, the inner face 17 comprises a recess 28 in which the brake dust collector 22 is received, in particular so as to be flush with adjacent surfaces of the brake drum 10.

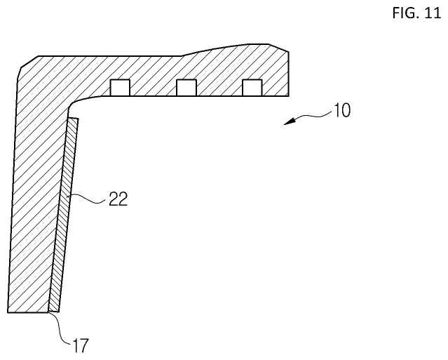

In FIG. 11, the brake dust collector 22 is a coating, in particular an adhesive coating, that is applied to the smooth and planar inner face 17. Alternatively, the brake dust collector 22 may be a removable adhesive disc that adheres to said inner face 17.

What is claimed is:

1. Brake drum for a vehicle drum brake,
the brake drum comprising:
an inner circumferential surface that extends around a rotation axis and that is configured to be contacted by a brake shoe for generating a braking effect; and
a brake dust collector;
wherein at least one dust-guiding groove is provided in the inner circumferential surface and extends towards the brake dust collector.

2. Brake drum according to claim 1,
wherein the dust-guiding groove extends from a first end portion at a first axial distance to the brake dust collector to second axial end portion that is axially closer to the brake dust collector.

3. Brake drum according to claim 1,
wherein the dust-guiding groove has a non-linear course.

4. Brake drum according to claim 1,
wherein the dust-guiding groove extends along the circumferential surface while covering a circumferential distance as well as an axial distance.

5. Brake drum according to claim 1,
wherein dust-guiding groove defines at least a segment of a helix shape.

6. Brake drum according to claim 1,
wherein at least two dust-guiding grooves are provided which, at least in one section of the inner circumferential surface, extend next to one another.

7. Brake drum according to claim 1,
wherein the inner circumferential surface is comprised by a friction ring that is arranged at an inner circumferential face of a drum member of the brake drum.

8. Brake drum according to claim 1,
wherein the circumferential surface is comprised by a drum member of the brake drum.

9. Brake drum according to claim 1,
wherein the brake dust collector is arranged in or at a surface of the brake drum that extends at an angle to the rotation axis, in particular wherein the brake dust collector is arranged at a wall section forming a base surface of the brake drum.

10. Brake drum according to claim 1,
wherein the brake dust collector comprises at least one of:
a mesh, in particular a metallic mesh;
an adhesive;
a fabric.
